(19) United States
(12) Patent Application Publication
(10) Pub. No.: US 2025/0145789 A1
(43) Pub. Date: May 8, 2025

(54) METHOD OF RECOVERING POLYMER MATERIAL

(71) Applicant: Crown Iron Works Company, Blaine, MN (US)

(72) Inventors: Benjamin W. Floan, Andover, MN (US); Maurice Johan Marie Bindels, Amersfoort (NL); Jeroen Pepijn Brakel, Alkmaar (NL)

(73) Assignee: Crown Iron Works Company, Blaine, MN (US)

(21) Appl. No.: 18/938,974

(22) Filed: Nov. 6, 2024

Related U.S. Application Data
(60) Provisional application No. 63/596,482, filed on Nov. 6, 2023.

(51) Int. Cl. C08J 11/08

(52) U.S. Cl. CPC C08J 11/08; C08J 2323/06; C08J 2467/06

(57) ABSTRACT

A method of recovering a polymer material including: providing an extrudate formed from an article comprising the polymer material; contacting the extrudate with a solvent to form a mixture; separating the mixture from the contacted extrudate and recovering the polymer material from the mixture.

### CROSS-REFERENCE TO RELATED APPLICATION

This application claims priority to U.S. Provisional Application No. 63/596,482, filed on Nov. 6, 2023, which is hereby incorporated by reference in its entirety for all purposes.

### FIELD

The present disclosure relates to the recycling of polymeric materials and more specifically to methods for recovering polymer materials from an extrudate via solvent extraction.

### BACKGROUND

Synthetic polymers are found in a wide range of products in almost every industry. Some common polymers used in the packaging and textile industries include polyester, polyethylene, polypropylene, polystyrene, and polyethylene terephthalate, among others.

Blended textiles are widely produced and used due to their unique characteristics such as fewer wrinkles and better absorbency. Blended textiles are also prized for their improved texture and feel of the fabric. The blending process refers to combining two or more types of stable fibers, such as polyester and cotton, using different percentages. Blending can be performed during different production stages of yarn manufacturing such as during the bale stage, at the carding stage, during the combing process, or at the rig-spinning stage. Additionally, yarns made from different materials are sometimes used to produce knitted or woven fabrics.

Textiles made of blended cotton and polyester fibers have a large share of the market. The desirable properties of these blends make them a popular choice for both producers and consumers. Because blended textiles exhibit good stretch, flexibility, and moisture management, they are used in a variety of garments and footwear.

Although some polymers exhibit good biodegradability, most synthetic polymers are difficult to break down because of their high chemical stability. In addition, it is difficult to fractionate the fibers in blended textiles and/or separate and sort them according to their type. These difficulties hinder the recyclability of these materials and their re-introduction into the supply chain.

Recycling processes aimed at reusing and repurposing polymer materials are gaining significance as concerns about sustainability are growing. Current recycling techniques usually involve energy intensive processes or hash chemical conditions in order to reduce the polymer back to its component monomers. The recycling of certain polymer materials, such as fabrics, presents challenges due to the loose fibers in the fibrous material snarling in equipment and obstructing operations.

A simple system for recovering polymer material from waste products that is efficient and suitable for blended textiles and other fibrous materials is desired. The present disclosure provides a method for creating an extrudate from an article including polymer material before recovering the recovering polymer material from the extrudate using a solvent extractor.

### SUMMARY

The present disclosure provides a process for recovering a polymer material from an article by using a solvent extractor. Advantageously, the article containing polymer material may be formed into an extrudate before it is contacted with the solvent so as to promote even extraction and prevent the tangling of loose fabric fibers in the extractor.

Embodiment 1 is a method of recovering a polymer material including: providing an extrudate formed from an article including the polymer material; contacting the extrudate with a solvent to form a mixture; separating the mixture from the contacted extrudate and recovering the polymer material from the mixture.

Embodiment 2 is the method of Embodiment 1, wherein the extrudate is formed by feeding the article including the polymer material into an extrusion device.

Embodiment 3 is method of Embodiment 2, wherein the article including the polymer material is dried before being fed into the extrusion device.

Embodiment 2 is the method of Embodiment 2, wherein the temperature is maintained at 80° C. to 120° C. as the article including polymer material is fed into the extrusion device.

Embodiment 5 is the method of Embodiment 2, further including the step of comminuting or processing the article including the polymer material to form article shreds before feeding the article into the extrusion device.

Embodiment 6 is the method of Embodiment 5 wherein an average diameter of the article shreds is from 20×20 mm to 40×40 mm or wherein an average size of the article shreds is from 4 cm² to 16 cm².

Embodiment 7 is the method of any one of Embodiments 1-6, wherein the moisture content of the article including polymer material is less than 14%.

Embodiment 8 is the method of any one of Embodiments 1-7, wherein the solvent is selected from the group consisting of 1,3-dimethyl-2-imidazolidone (DMI), dimethyl terephthalate (DMT), ethylene glycol, dimethylformamide (DMF), dichloromethane (DCM) and dimethyl sulfoxide (DMSO), and mixtures thereof.

Embodiment 9 is the method of any one of Embodiments 1-8, wherein the solvent is 1,3-dimethyl-2-imidazolidone (DMI).

Embodiment 10 is the method of any one of Embodiments 1-9, wherein the solvent is at a temperature of from 120° C. to 220° C.

Embodiment 11 is the method of any one of Embodiments 1-10, wherein the polymer material comprises polyester, polyethylene, polyethylene terephthalate, polyamide, polyurethane, elastane, rayon, high density polyethylene, low density polyethylene, polypropylene, polystyrene, polyvinyl chloride, polycarbonate, polymethyl methacrylate, acrylonitrile butadiene styrene or mixtures thereof.

Embodiment 12 is the method of any one of Embodiments 1-11, wherein the polymer material comprises polyethylene terephthalate (PET), polytrimethylterephthalate (PTT), or polyester (PE).

Embodiment 13 is the method of any one of Embodiments 1-12, wherein the article comprises a fiber.

Embodiment 14 is the method of any one of Embodiments 1-13, wherein the fiber comprises staple fiber, continuous filament fiber, or mixtures thereof.

Embodiment 15 is the method of any one of Embodiments 1-14, wherein the fiber size is from 0.1 to 10 denier.

Embodiment 16 is the method of any one of Embodiments 1-15, wherein the article comprises a plastic waste.

Embodiment 17 is the method of any one of Embodiments 1-16, wherein the article comprises footwear, knitted fabric, woven fabric, a non-woven, carpet, or mixtures thereof.

Embodiment 18 is the method of any one of Embodiments 1-17, wherein the extrudate comprises pellets.

Embodiment 19 is the method of any one of Embodiments 1-18, wherein the pellets have an average diameter in cross section of from 6 mm to 16 mm or an average size of from 0.36 cm² to 2.6 cm².

Embodiment 20 is the method of Embodiment 18, wherein the pellets have an average weight of from 0.01 g to 100 g.

Embodiment 21 is the method of any one of Embodiments 1-20, further including a step of pre-wetting the extrudate before it is contacted with solvent.

Embodiment 22 is the method of any one of Embodiments 1-21, wherein the recovering step involves separating the polymer material from the solvent and drying it.

Embodiment 23 is the method of any one of Embodiments 1-22, wherein the purity of the recovered polymer material is at least 70%.

Embodiment 24 is the method of any one of Embodiments 1-23, wherein the contacting step is carried out in a percolation type extractor.

Embodiment 25 is the method of Embodiment 24, wherein the percolation extractor comprises: an extraction chamber; a screen configured to support the extrudate; and a conveyance system configured to convey the extrudate along the screen in a direction of material travel.

Embodiment 26 is the method of Embodiment 24 or Embodiment 25, wherein the extraction chamber further is configured to maintain a solvent pool in which the extrudate supported on the screen is partially immersed during operation.

Embodiment 27 is the method of any one of Embodiments 24-26, wherein the extraction chamber further comprises a plurality of weirs extending from the top surface of the extraction chamber configured to drip solvent over the extrudate on the screen.

Embodiment 28 is the method of any one of Embodiments 24-27, wherein the solvent is contacted with the extrudate in a countercurrent arrangement.

Embodiment 29 is the method of any one of Embodiments 24-28, wherein the solvent and extrudate have a contact time of 1000 seconds to 10,000 seconds.

Embodiment 30 is the method of any one of Embodiments 24-29, wherein the ratio of extrudate to solvent is from 1:1 to 1:3

Embodiment 31 is the method of Embodiment 1, wherein the contacting step is carried out in an immersion type extractor.

Embodiment 32 is the method of Embodiment 31, wherein the immersion type extractor comprises: a housing with an immersion portion configured to maintain a liquid pool in which the extrudate is immersible during operation of the extractor; a conveyor assembly extending through the liquid pool configured to transmit the extrudate through the housing.

Embodiment 33 is the method of Embodiment 31 or Embodiment 32, wherein the housing further comprises a plurality of bed decks positioned inside the housing, each providing a surface along with the extrudate material is conveyed during the operation of the extractor, and at least one of the plurality of bed decks being positioned at a vertically elevated position relative to another of the plurality of bed decks so as to define a drop zone where the extrudate material drops from the vertically elevated bed deck to a lower bed deck.

Embodiment 34 is the method of any one of Embodiments 31-33, wherein the solvent and extrudate have a contact time of 1000 seconds to 10,000 seconds.

Embodiment 35 is the method of any one of Embodiments 31-34, wherein the ratio of extrudate to solvent is from 1:1 to 1:5.

Embodiment 36 is the method of any one of Embodiments 31-35, wherein the solvent and the extrudate are contacted in a countercurrent arrangement.

Embodiment 37 is the method of any one of Embodiments 31-36, wherein the immersion type extractor further comprises: a plurality of recycle stages within the immersion portion, wherein each stage has a solvent recycle inlet positioned to direct a flow of solvent upwardly into the immersion portion wherein the solvent intermixes with the extrudate material; and a further solvent recycle outlet.

Embodiment 38 is the method of any one of Embodiments 31-37, wherein the solvent recycle inlets comprise a whistle inlet and a distribution manifold.

Embodiment 39 is the method of Embodiment 37 or Embodiment 38, wherein the solvent recycle outlet is configured as an overflow weir and/or a suction outlet in fluid communication with the immersion portion of the housing.

Embodiment 40 is the method of any one of Embodiments 37-39, wherein the conveyor assembly is configured to move the extrudate material in a countercurrent direction relative to solvent flow.

Embodiment 41 is the method of any one of Embodiments 37-40, wherein the solvent and extrudate have a contact time of 1000 seconds to 5000 seconds.

Embodiment 42 is the method of any one of Embodiments 37-41, wherein the ratio of extrudate to solvent is from 1:1 to 1:3.

### BRIEF DESCRIPTION OF THE DRAWINGS

The accompanying drawings are included to provide a further understanding of the disclosure and are incorporate in and constitute a part of this specification, illustrate embodiments, and together with the description serve to explain the principles of the disclosure.

FIG. 1 depicts an image of shreds of an article including a polymer material.

FIG. 2 depicts an image of extruded pellets of the shredded article form

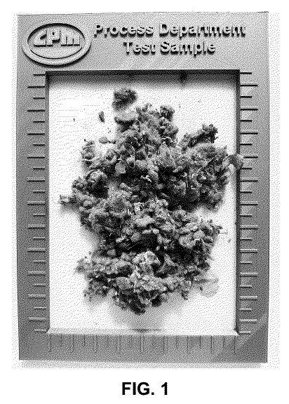

FIG. 1.

FIG. 3 depicts a perspective view of one example configuration of a percolation extractor, shown with some parts broken away for purposes of illustration.

FIG. 4 depicts an isometric view of one example configuration of an immersion extractor, shown with some parts broken away for purposes of illustration.

FIG. 5 depicts an isometric sectional view of one example configuration of an immersion extractor, shown with some parts broken away for purposes of illustration.

FIG. 6 depicts an isometric sectional view of an immersion extractor's arrowhead assembly

FIG. 7 depicts an isometric sectional view of an immersion extractor's inlet whistle.

FIG. 8 depicts an isometric sectional view of a portion of an immersion extractor's solvent handling system.

FIG. 9 depicts an isometric sectional view of an immersion extractor's scupper.

FIG. 10 depicts an isometric view of the lower portion of an immersion extractor's housing.

### DETAILED DESCRIPTION

### I. Definitions

As used herein, the term “about”, when used in connection with numerical values such as recited weight percentages of the components of the present compositions, pressures, and temperatures includes a deviation of ±0.3% from the recited weight percentage.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

As used herein, the phrase “within any range encompassing any two of these values as endpoints” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

As used herein, the term “polymer material” refers to a substance which comprises one or more homopolymers, copolymers or terpolymers. In a non-limiting example, the polymer material may include a hydrocarbon polymer, a fluoropolymer, a polyolefin, or a combination thereof.

### II. Extrudates

As discussed above, the processing and/or recycling of fibrous materials, including blended textiles, presents several challenges. If machinery is used, loose fibers may clog small screens or tangle in small moving parts. Furthermore, the complex structure of blended synthetic fibers makes it difficult to fractionate the components and process them individually for recycling.

The present method is aimed at overcoming these challenges. In a first step, the method of recovering a polymer material may involve providing an extrudate formed from an article including the polymer material. By forming a hard compacted extrudate from a loose woven material, the processability of the polymer material may be improved. For example, as the extrudate is processed through machinery, it is less likely to clog screens or tangle on moving parts.

The article including polymer material may be fibrous or non-fibrous. If the article comprises a fiber, the fiber may be a staple fiber, a continuous filament fiber, or mixtures thereof. The fiber size may be from as low as 0.1 denier, 1 denier, 2 denier, 3 denier, 4 denier, 5 denier, 6 denier, 7 denier, or as high as 8 denier, 9 denier, 10 denier, 11 denier, 12 denier, 13 denier, 14 denier, 15 denier, or within any range encompassed by any two of the foregoing values as endpoints. For example, the fiber size may be from 0.1 denier to 10 denier, or from 0.1 to 5 denier, or may have any size encompassed by the foregoing values. The article may also comprise a plastic waste, knitted fabric, woven fabric, non-woven fabric, carpet, or mixtures thereof.

The polymer material may include polyester, polyethylene, polyethylene terephthalate, polyamide, polyurethane, elastane, rayon, high density polyethylene, low density polyethylene, polypropylene, polystyrene, polyvinyl chloride, polycarbonate, polymethyl methacrylate, acrylonitrile butadiene styrene or mixtures thereof.

Specific sources of non-fibrous articles comprising polymer materials include plastic bags, plastic cutlery, plastic straws, plastic water bottles, food wrappers, blister packs, shrink wrap, food trays, plastic storage containers, cables, plastic connectors, pipes, insulation, siding, roofing, automotive trim, dashboard components, syringes, IV bags, pill bottles, plastic mulch film, silage bags, plastic pallets, fishing lines, fishing nets, and shipping containers.

Specific sources of fibrous articles comprising polymer materials include shirts, pants, dresses, suits, jackets, socks, underwear, swimsuits, pajamas, uniforms, sportswear, sneakers, running shoes, boots, sandals, slippers, bedding, curtains, drapes, towels, tablecloths, dishcloths, carpets, furniture upholstery, wall coverings, handbags, backpacks, wallets, belts, hats, scarves, ties, gloves, mattress covers, shower curtains, camping tents, sleeping bags, umbrellas, hammocks, car seats, seat covers, headliners, floor mats, surgical gowns, medical masks, bandages, filters, insulation, conveyor belts, stuffed animals, and sports equipment.

In addition to polymeric and/or fibrous materials, the articles may further comprise other additives or fillers such as plasticizers like diisononyl phthalate, dioctyl phalate, dibutyl phthalate, or trimetallic anhydride; heat stabilizers; UV stabilizers; antioxidants such as hindered phenols; light stabilizers, flame retardants such as antimony trioxide, aluminum trihydrate, or melamine cyanurate; pigments, dyes, color concentrates, antistatic agents, fillers such as calcium carbonate, talc, kaolin clay, glass fibers, mica, silica, or carbon black; reinforcements such as aramid fibers, jute, or flax; plastic modifiers such as ethylene-propylene rubber, elastomers, or processing aids; lubricants such as stearates, esters, silicones, or fatty acids, mold release agents; cross-linking agents such as peroxides or sulfur; plastic tougheners such as elastomers or thermoplastic elastomers; processing aids such as acrylics or maleic anhydrige grafting agents; antimicrobial agents such as silver nanoparticles; zinc pyrithione, or quaternary ammonium compounds; conduct additives such as carbon nanoubes, graphene, or semi-conducting polymers; biodegradable additives such as polylactic acid, starch, or olyhydroxyalkanoates; fragrances; release agents; and foaming agents.

The process of forming the extrudate may involve feeding the article including the polymer material into an extrusion device. Suitable extrusion devices include single-screw extruders, twin-screw extruders (coaxial twin screw, conical twin-screw, co-rotating twin-screw, and parallel twin screw), and three-screw extruders. Pellet mills or other similar devices with a roller and die with holes may also be used.

A variety of articles including polymer materials may be combined and fed into an extrusion device, or a single type of article may be fed in as well. The composition of the resulting extrudate, therefore, may comprise a mixture of different polymeric materials from different sources, or it may comprise a single polymeric material.

Before the article including polymer, material is fed into an extrusion device, it may be prepared or conditioned. In some embodiments, a binder, such as cellulosic material, e.g., starch, may be added to the articles to help the extruded material maintain its shape. In some embodiments, no binders are needed because the heat produced during the extrusion process is sufficient to melt and bind the material together.

During the process of forming the extrudate, the moisture content of the articles including polymer material may be controlled by either adding moisture or by drying out the articles. Maintaining a consistent moisture level throughout the extrusion process ensures the resulting extrudates have optimal structural integrity and do not prematurely break apart. In some embodiments, the moisture content of the articles including polymer material may be less than 15%, less than 14%, less than 13%, less than 12%, less than 11% less than 10%, less than 9%, less than 8%, less than 7%, less than 6%, less than 5%, less than 4%, less than 3%, less than 2%, less than 1%, or within any range encompassed by any two of the foregoing values as endpoints. For example, the moisture content of the articles including polymer material may be from 3% to 14%, or from 5% to 10%. The moisture content of the articles including polymer material may be measured using gravimetric methods, capacitance methods, microwave moisture sensors, or infrared thermography.

The temperature range for the process of forming the extrudate may be as low as 50° C., 60° C., 70° C., 80° C., 90° C., 100° C., or as high as 110° C., 120° C., 130° C., 140° C., 150° C., or within any range encompassed by any two of the foregoing values as endpoints. For example, the temperature range for the process of forming the extrudate may be from 80° C. to 120° C.

In some embodiments, the article including the polymer material may be comminuted or processed to form article shreds before it is fed into the extrusion device. The article shreds may be a relatively smaller size compared to the original article. In some embodiments, the average diameter of the article shreds is as low as 10×10 mm, 15×15 mm, 20×20 mm, 25×25 mm, 30×30 mm, 35×35 mm, 40×40 mm, 45×45 mm, 50×50 mm, or within any range encompassed by any two of the foregoing values as endpoints. For example, the average diameter of the article shreds may be from 20×20 mm to 40×40 mm. In some embodiments, the average size of the article shreds may be as low as 1 cm², 2 cm², 3 cm², 4 cm², 5 cm², 6 cm², 7 cm², 8 cm², 9 cm², 10 cm², 11 cm², 12 cm², 13 cm², 14 cm², 15 cm², 16 cm², 17 cm², 18 cm², 19 cm², 20 cm², or within any range encompassed by any two of the foregoing values as endpoints. For example, the average size of the article shreds may be from 4 cm² to 16 cm². FIG. 1 depicts an image of article shreds having an appropriate size and diameter.

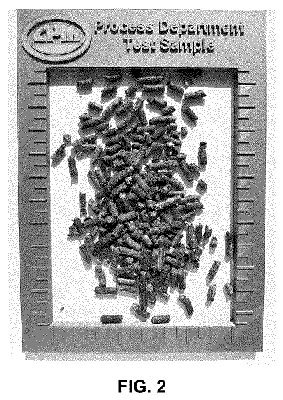

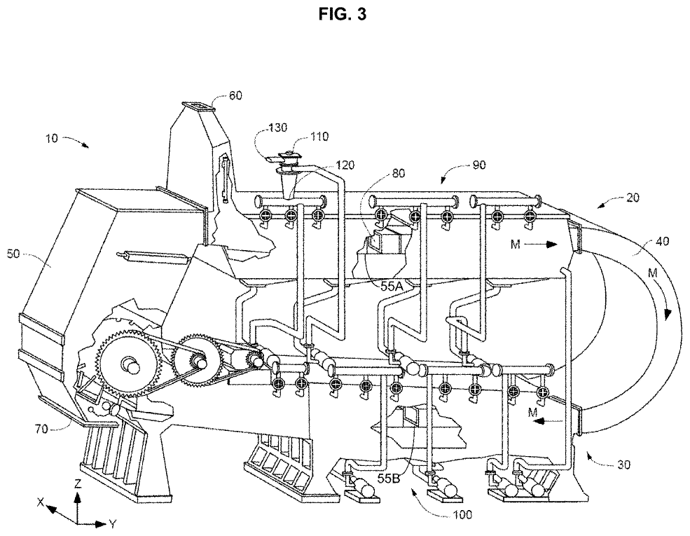

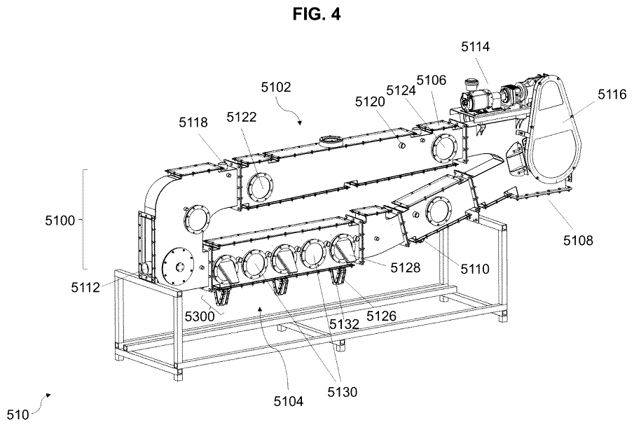

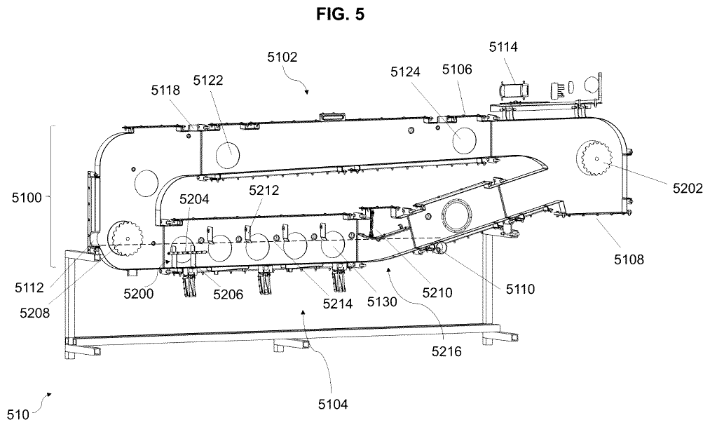

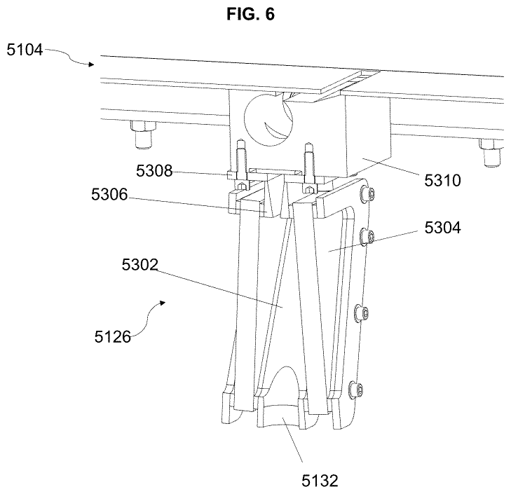

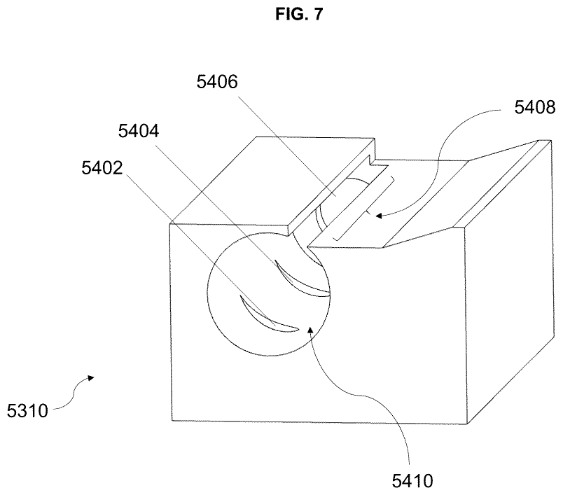

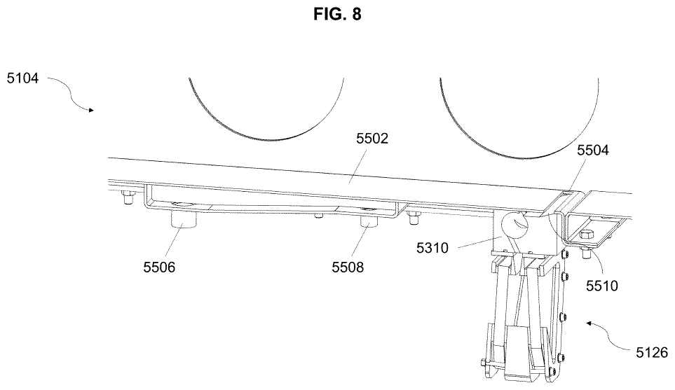

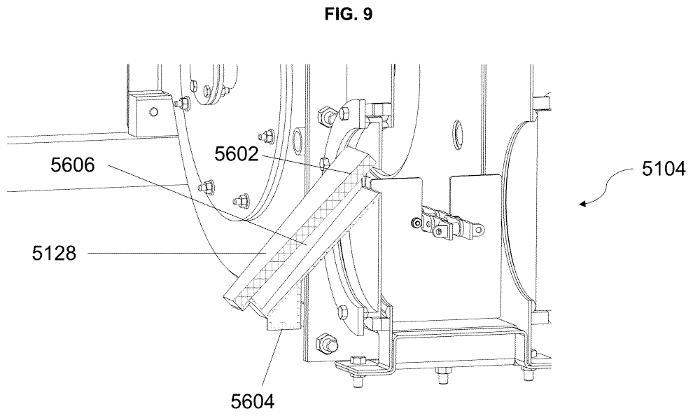

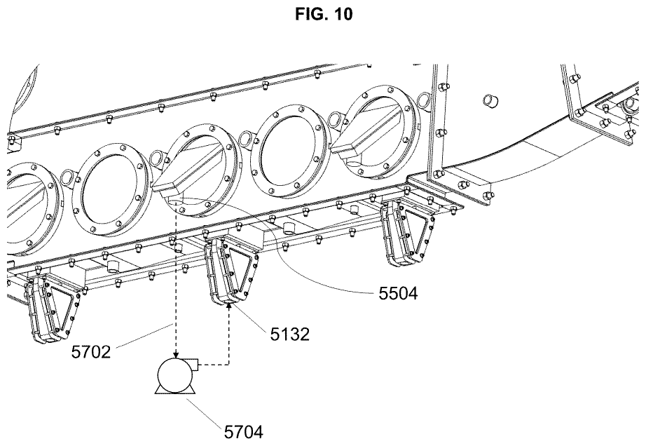

In some embodiments, the extrudate may be in the form of pellets, chips, or flakes. The pellets may have an average diameter in cross section of as low as 1 mm, 2 mm, 3 mm, 4 mm, 5 mm, 6 mm, 7 mm, 8 mm, 9 mm, 10 mm, 11 mm, 12 mm, or as high as 13 mm, 14 mm, 15 mm, 16 mm, 17 mm, 18 mm, 19 mm, 20 mm, 25 mm, 25 mm, or within any range encompassed by any two of the foregoing values as endpoints. For example, the pellets may have an average diameter of from 6 mm to 16 mm. the pellets may have an average size of as low as 0.1 cm², 0.2 cm², 0.3 cm², 0.36 cm², 0.4 cm², 0.5 cm², 0.7 cm², 1 cm², 2 cm², 2.6 cm², 3 cm², 4 cm², 5 cm², 6 cm², 7 cm², 8 cm², 9 cm², 10 cm², 11 cm², 12 cm², 13 cm², 14 cm², 15 cm², 16 cm², 17 cm², 18 cm², 19 cm², 20 cm², or within any range encompassed by any two of the foregoing values as endpoints. For example, the average size of the article shreds may be from 0.36 cm² to 2.6 cm². FIG. 2 depicts an image of extruded pellets formed from the article shreds in FIG. 1.

### III. Solvent Extraction

Once the article including polymer material is formed into an extrudate, it may be extracted in a liquid solvent extractor to recover the polymer material.

Liquid solvent extractors are usable in a variety of contexts and are particularly applicable for use in processing solid products that comprise an extract. In some applications, granular or flake material is treated with a solvent so that some amount of a component of the granular or flake material (an extract) is dissolved by the solvent in solution and separated.

Processing fibrous materials in a solvent extractor presents several challenges. Fibrous materials will float in the solvent, hindering the extraction of recyclable materials. Additionally, fibers can tangle around moving parts, inhibiting efficiency of the extraction process and potentially damaging the machinery. Fibers may also block screens, clogging the flow of solvent through the extractor. By forming the fibrous polymer material into an extrudate, it can be processed through the liquid extractor more efficiently, without tangling or clogging the machinery.

Once the polymer material is formed in to an extrudate may be introduced to an extractor housing including an inlet and an outlet. Generally, the extrudate is transported from the extractor inlet to the extractor outlet. A drag conveyor may be incorporated into the extractor to transport the extrudate and the extrudate may form a bed atop the drag conveyor.

Generally, the bed of extrudate comes into contact with solvent which makes contact with the extrudate and dissolves the useful extracts or impurities, such as dyes.

In embodiments where the extrudate is formed from dyed fabric, the solvent may dissolve the dye such that the color is removed. The resulting colorless fabric fibers may optionally be sorted, packaged, or bailed before be recycled directly back into making fabrics of various types and colors.

The solvent may contact the extrudate in various ways. In percolation extractors, the solvent may be poured over the bed of extrudate. In immersion extractors, the solvent forms a pool through which the material is conveyed.

Once the extrudate is contacted with the solvent, it forms a mixture. The mixture may comprise the solvent and dissolved polymer material. The ratio of solvent to dissolved polymer material in the mixture may be 1:20, 2:20, 3:20, 4:20, 5:20, 6:20, 7:20, 8:20, 9:20, 10:20, or within any range encompassed by any two of the foregoing ratios as endpoints. For example, the ratio of solvent to dissolved polymer material in the mixture may be from 1:20 to 10:20, 2:20 to 9:20, or 3:20 to 8:20. Suspended within the mixture there may be remains of the contacted extrudate which are not soluble in the solvent. The amount of solids in the mixture may be as low as 1 wt. %, 5 wt. %, 10 wt. %, 15 wt. %, 20 wt. %, or as high as 25 wt. %, 30 wt. %, 35 wt. %, 40 wt. %, or within any range encompassed by any two of the foregoing values as endpoints. For example, the amount of solids may be from 5 wt. % to 25 wt. %, from 10 wt. % to 25 wt. %, or from 15 wt. % to 20 wt. %.

The solvent used in the extractor may be 1,3-dimethyl-2-imidazolidone (DMI), dimethyl terephthalate (DMT), ethylene glycol, dimethylformamide (DMF), dichloromethane (DCM) and dimethyl sulfoxide (DMSO), and mixtures thereof.

A particularly preferred solvent is 1,3-dimethyl-2-imidazolidone (DMI).

The solvent temperature may be tuned to promote the most efficient extraction for different materials. The solvent temperature may be as low as 100° C., 110° C., 120° C., 130° C., 140° C., 150° C., or as high as 160° C., 170° C., 180° C., 190° C., 200° C., or within any range encompassed by any two of the foregoing values as endpoints. In general, it is preferred that the solvent be maintained at a temperature of from 120° C. to 220° C.

After the desired polymer material has been fully dissolved in the mixture, the mixture may be separated from the contacted extrudate in the extractor. Typically, this is done by allowing the solvent to drip away from a bed of the extrudate or by conveying a bed of extrudate away from a solvent pool. The contacted extrudate may be discarded or saved for another recycling. The mixture comprising the dissolved polymer material may then be removed from the extractor and then further processed to recover the polymer material.

Recovering the polymer material from the mixture may be done via several methods, depending on the properties of the solvent. Suitable methods include evaporation, distillation, filtration, or crystallization.

Once recovered from the solvent, the polymer material may be subjected to further washing, drying, and purification steps until a desired purity is reached.

The recovered polymer material may have a purity of as low as 50%, 55%, 60%, 65%, 70%, 75%, or as high as 80%, 85%, 90%, 95%, 97%, 99%, or within any range encompassed by any two of the foregoing values as endpoints.

The present disclosure contemplates several types of liquid-solvent extractors, discussed below, which may be used conjunction with the methods described above.

### A. Percolation Type Extractors

In one embodiment, the method for recovering polymer material comprises a percolation extractor. In percolation extractors, solvent is typically dripped over the extrudate from above as the extrudate is conveyed forwards. Generally, while solvent is poured over a bed of the material, the material is transported from the extractor inlet to the extractor outlet. The efficiency of the extractor is the measure of the rate at which the solvent is able to effectively remove the targeted component from the material.

The bed of extrudate comprising polymer being conveyed is essentially a porous medium. Consequently, as solvent is repeatedly poured onto the top of the bed, it washes through the bed, making contact with the material, and draining out through a screen supporting a bed of the material. The hard and dense extrudate may contain a minimal amount of loose fibers or threads, allowing the solvent to pass through the material bed and screen without clogging.

In general, a percolation extractor comprises an extraction chamber, a screen configured to support the extrudate, and a conveyance system configured to convey the extrudate along the screen in a direction of material travel.

FIG. 3 is a perspective view of one example configuration of a percolation extractor 10, shown with some parts broken away for purposes of illustration, that can utilize a screen according to the disclosure. In particular, extractor 10 is illustrated as a percolation extractor that includes a housing defining a passageway in the form of a loop disposed in a vertical plane. Extractor 10 includes upper and lower extraction sections 20, 30 each with a series of extraction chambers, a generally arcuate hollow transfer section 40 having its opposite upper and lower ends connected to first ends of the upper and lower extraction sections respectively, and a hollow, generally vertical return section 50 connected at its upper and lower ends respectively to the other ends of the upper and lower extraction sections. The upper extraction section can include an inlet portion 60 for delivery of extrudate to the interior thereof in closely spaced relation to the upper end of the return section, and the lower end of the return section can define an opening 70 for discharge of the material after the product-of-interest has been extracted therefrom. The number of extraction chambers, or stages, provided by the extractor can vary depending on the desired size of the extractor. The extractor includes at least one extraction chamber, or stage, and typically includes multiple stages (e.g., 6 stages, 8 stages, or more). A Model Ill extractor commercially available from Crown Iron Works Company of Minneapolis, Minn., is a specific example of an extractor of this type.

In operation, extrudate being processed is introduced into extractor 10 through inlet 60, processed within the extractor, and discharged through outlet 70. To support the extrudate processed within extractor 10, the extractor can include a bed deck 55 that extends through one or more extraction stages. For example, when extractor 10 is configured as a continuous loop extractor as shown in FIG. 3, the extractor may have an upper bed deck 55A and a lower bed deck 55B (referred to collectively as “bed deck 55”). The upper bed deck 55A and lower bed deck 55B may form a continuous surface on top of which extrudate being processed is conveyed through upper extraction section 20 and lower extraction section 30, respectively. For example, liquid extraction fluid dispensed on top of extrudate being transported through extractor 10 may percolate through the thickness of a bed of the extrudate before draining out through bed deck 55. As will be described, bed deck 55 can be implemented using a screen structure according to the disclosure.

To move extrudate through extractor 10, the extractor can include a conveyance system. Extractor 10 in FIG. 3 includes a conveyance system 80, which can extend longitudinally through the looped passageway and be driven in a material flow direction “M” to move the material as a bed from the inlet portion 60 through the upper extraction section 20 toward and downwardly through the transfer section 40, and through the lower extraction section 30 toward the lower end of the return section and the discharge opening 70. In some configurations, the conveyor system includes a pair of laterally spaced endless link chains and a plurality of longitudinally spaced flights that extend transversely of the chains. A motor and gearing may be provided to drive the conveyor. For example, the conveyor may include flights that drag across the top surface of bed deck 55, causing extrudate introduced through inlet 60 to convey across the top surface of the bed deck toward outlet 70.

In the example of FIG. 3, extractor 10 also includes a fluid supply system 90 disposed above the extrudate and configured to apply a fluid to the extrudate in each extraction chamber. Extractor 10 also includes a fluid removal system 100 disposed below the extrudate and configured for removing the fluid after it has passed through the extrudate in each extraction chamber. In some examples, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed extrudate, allowing the extraction fluid to then percolate through the material. The fluid removal system may include a network of drains, pumps, and pipes to collect the fluid after it has percolated through the extrudate in each extraction chamber and deliver it to the fluid supply system of another extraction chamber or remove it from the system.

In some examples, fluid having passed through the extrudate is collected by a fluid removal system 100 and delivered to a cyclone-type separator 110 before it is removed from the extractor to separate any solid fines from the fluid before fluid discharge. The separator can have a lower discharge end 120 connected to an extraction chamber for re-delivery of separated extrudate in the extractor, generally in the first extraction chamber after the fresh extrudate inlet 60. An outlet conduit 130 of the separator 110 delivers the fluid, generally a mixture of extraction fluid and soluble components extracted from the extrudate into the extraction fluid to other equipment, not shown, for separating the extraction fluid from the material extracted from the extrudate being processed.

As extrudate is conveyed through the extractor, spray headers or weirs from the fluid supply system 90 may drip or pour recycled extraction fluid on the top of the material. The material can percolate through the material and through openings in bed deck 55, where it is collected in the network of drain pipes and may be delivered back to the network of spray headers for reapplication to the extrudate in a different extraction chamber. To support the porous bed deck 55 inside of the extractor housing, a support frame may be provided under the bed deck that holds the bed deck in a fixed position during operation.

In some embodiments, the extrudate may be pre-wetted before it is contacted with the solvent from the fluid supply system 90. The pre-wetting solvent may be 1,3-dimethyl-2-imidazolidone (DMI), dimethyl terephthalate (DMT), ethylene glycol, dimethylformamide (DMF), dichloromethane (DCM), dimethyl sulfoxide (DMSO), water and mixtures thereof.

In the configuration shown, a delivery conduit connected to a source of liquid extraction fluid supply (not shown) is connected to the fluid supply system to supply fresh extraction fluid in at least one extraction chamber. In some embodiments, fresh extraction fluid is applied to the material in the last extraction chamber before the extrudate discharge 70. For example, fresh extraction fluid may be applied to the material in the last extraction chamber before discharge 70 and, after being collected at the bottom of the chamber, recycled and applied on top of extrudate in an adjacent upstream extraction chamber. By recycling collected extraction fluid from one extraction chamber to an adjacent upstream extraction chamber, liquid extraction fluid and extrudate being processed can move in countercurrent directions through the extractor. For example, as extraction fluid is conveyed sequentially through adjacent extraction chambers between a fresh extraction fluid inlet adjacent discharge 70 and an enriched extraction fluid outlet adjacent inlet 60, the concentration of extract relative to extraction fluid may increase from a relatively small extract-to-extraction fluid ratio to a comparatively large extract-to-extraction fluid ratio. Similarly, as the extrudate is conveyed in the opposing direction, the concentration of extract in the solid feedstock decreases from a comparatively high concentration at the inlet 60 to a comparatively low concentration at the outlet 70.

To help keep bed deck 55 clean and reduce clogging or complete blockage of the apertures in the bed deck, extractor 10 may include a wash system configured to wash the bed deck (e.g., intermittently, continuously) during operation. The wash system may include a conduct connected to a source of wash liquid and a plurality of nozzles positioned to direct washing liquid against bed deck 55. The washing system may spray a washing liquid that is the same (e.g., same composition) as the extraction fluid used to extract the extrudate being processed. In different applications, the washing system may be positioned to spray washing liquid downwardly on a top surface of bed deck 55, or spray washing liquid upwardly on a bottom surface and underside of the bed deck, or both. Moreover, the nozzles of the washing system may or may not move (e.g., translate relative to bed deck 55), e.g., to increase the surface area of the bed deck washed. One example wash system that can be used is described in U.S. patent application Ser. No. 14/717,789, filed May 20, 2015, the entire contents of which are incorporated herein by reference.

### B. Immersion Type Extractors

In general, immersion type extractors involve liquid-solid countercurrent extraction processes that enable the extraction of one or more desired products from extrudate which is immersed in a pool of solvent. In some examples, an extractor conveys a continuous flow of extrudate from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the extrudate is conveyed in the opposing direction, the concentration of extract in the solid feedstock decreases from a comparatively high concentration at the inlet to a comparatively low concentration at the outlet. The amount of time the extrudate remains in contact with the solvent within the extractor (which may also be referred to as residence time) can vary, for example depending on the material being processed and the operating characteristics of the extractor, although will typically be within the range of 15 minutes to 3 hours, such as 30 minutes, 1 hour, 2 hours, 3 hours, or within any range encompassed by these values as endpoints.

Referring to the drawings wherein like reference numerals denote like elements throughout the several views, FIG. 4 is an isometric view of an extractor 510. As shown, the extractor 510 has a housing 5100 which is coupled to a conveyor system 5200 and a solvent handling system 5300. FIG. 5 is an isometric view of the Z-axis cross section of extractor 510 showing the features in the interior of housing 5100.

Referring to FIGS. 5 and 6, the housing 5100 has an upper portion 5102, and a lower portion 5104. In some embodiments, the extrudate for extraction is supplied in a continuous flow from a extrudate source into the extrudate inlet 5106. The extrudate is conveyed from inlet 5106 through the extractor using the conveyor system 5200 towards the extrudate outlet 5108. The upper portion 5102 also has a vent 5118, upper portion weir 5120, and view ports 5122 and 5124. The vent 5118 and upper portion weir 5120 are configured to provide flow control in the reactor by maintaining an appropriate level of backpressure inside the housing 5100. The lower portion 5104 of extractor 510 also has a solvent inlet 5110 and a solvent outlet 5112. The lower portion 5104 is also equipped with multiple viewports 5130 to allow a user to observe the inside of the extractor. The lower portion 5104 of the extractor also has an inclined drain section 5216 where the extrudate starts to rise above the solvent pool (designated generally in FIG. 5 by solvent line 5214).

In some embodiments, the housing 5100 is coupled to the conveyor system 5200 which generally includes a chain 5204 that connects to paddles 5206. In FIG. 5, only a section of the chain 5204 and paddles 5206 are shown to avoid obfuscating features of the extractor 10. A remainder of the path of the chain 5204 is shown in broken lines extending in a continuous circuit between the upper portion 5102 and the lower portion 5104. Though not shown, the conveyor system 5200 has repeating chain and paddles which loop around through the entire housing 5100 along the path indicated by the broken line in FIG. 5. In some embodiments, the upper portion 5102 of extractor 510 has an external drive motor 5114 which is coupled to the conveyor assembly 5200 via drive sprocket assembly 5116. The conveyor assembly is driven by internal drive sprocket 5202, which connects to chain 5204 (not shown) and is powered by the external drive motor 5114. The conveyor assembly also loops around internal idler sprocket 5208. Tensioner 5210 can be adjusted to apply greater or lesser downward pressure to the conveyor assembly 5200 for maintenance and to keep chain 5204 firmly seated on sprockets 5204 and 5208 during operation.

In some embodiments, the housing 5100 is coupled to solvent handling system 5300 which sits in the lower portion 5104 of the housing. The solvent handling system 5300 includes a solvent pool, the top of which is indicated generally by solvent line 5214. The solvent handling system 5300 includes arrowhead assembly 5126 and scupper 5128 (FIG. 4). The system 5300 also includes several stage separation baffles 212 which are positioned slightly above the solvent line 5214. The tip of scupper 5128 has a solvent outlet 5130 which points downwards. The bottom side of arrowhead assembly 126 has a solvent inlet 132 (FIG. 4).

FIG. 6 is an isometric view of arrowhead assembly 5126 showing a longitudinal section of the assembly 5126. Distribution manifold 5302 has a solvent inlet 5132 at the bottom. The distribution manifold is configured such that solvent generally flows in an upward direction from the solvent inlet 5132 towards the lower portion 5104 of the housing. In some embodiments, the sides of the distribution manifold are glass panels 5304 which act as viewports. The arrowhead cover 5306 has a tapered shape that opens upwards into inlet whistle plate 5308 which is bolted to the inlet whistle block 5310. As shown, the tapered shape increases in width from the solvent inlet 5132 to inlet whistle plate 5308. The design of the arrowhead assembly 5126 is optimized to provide sufficient velocity of the solvent in recycle communicating with the material so that the entrained solids are conveyed back into the material bed and do not settle out in the inlet whistle or the arrowhead assembly 5126.

FIG. 7 is an isometric view of an isolated inlet whistle block 5310. The inlet whistle block 5310 has a manifold 5410 (e.g., in the shape of a cylinder) in the middle with two round holes 5402 and 5404. Holes 5402 and 5404 pass through to the underside of the inlet whistle block 5310 and connect underneath to the opening in the top of arrowhead cover 5306, allowing solvent to pass through. The inlet whistle block 5310 also has an opening (e.g., round hole) 5406 at the back which opens into the lower portion 5104 of the housing. The top of the inlet whistle block 5310 has an elongate mouth 5408 that runs parallel to its length. Elongate mouth 5408 opens into the lower portion 5104 of the housing above.

FIG. 8 is an isometric view of a longitudinal section of a portion of the lower housing 5104 and arrowhead assembly 5126. The bottom plate 5502 of the lower housing 5104 has a mouth 5504 which opens into an elongate recess 5510 at the top of inlet whistle block 5310. This opening fluidly couples the arrowhead assembly 5126, the inlet whistle block 5310, and the lower housing 5104.

In some embodiments, the solvent handling system 5300 includes solvent recycle stage that allows for solvent to be drained away from the solvent pool then pumped back into the lower housing. FIG. 9 is an isometric view of an X-axis cross section, or transverse section, of a portion of the lower housing 5104. The cross-section slices through scupper 5128 showing a hollow channel 5606 on the inside. The scupper has an inlet 5602 which opens into the inside of lower housing 5104 and an outlet 5604 which is open to the outside of the extractor 10 (FIG. 4).

As shown in FIGS. 5-10, the extractor 510 generally includes a feed portion which includes the components of the upper housing 5102 and an immersion portion which includes the components of the lower housing 5104. The feed portion is configured to receive and convey a extrudate through the extractor to the immersion portion. The immersion portion, in turn, is configured to maintain a solvent pool in which the extrudate is immersed and subjected to counterflow of solvent during operation of the extractor 510.

During operation of extractor 510, extrudate enters through extrudate inlet 5106. Once inside the feed portion, the extrudate (not shown) is picked up by the conveyor assembly 5200 and carried towards the immersion portion for extraction.

In the immersion portion, the extrudate comes into contact with the solvent pool which fills the lower housing 5104 up to line 5214. In some embodiments, the extrudate remains completely submerged in the pool of solvent as it travels through at least the lower housing 5104 of the extractor, or it may be submerged as it travels through substantially all of the extractor 510 (e.g., except when adjacent to solids inlet 5106 and solids outlet 5108).

The speed of the conveyor assembly may be tuned to adjust the rate of travel of the extrudate through the solvent pool. As different extrudates will have extractants that dissolve at different rates, a user may adjust the conveyor speed to optimize extraction. In preferred embodiments, the speed of the conveyor may be as low as 1 inch/min, 2 inch/min, 3 inch/min, 4 inch/min, 5 inch/min, 6 inch/min, 7 inch/min, 8 inch/min, 9 inch/min, 10 inch/min, 11 inch/min, 12 inch/min, 13 inch/min, 14 inch/min, 15 inch/min, 16 inch/min, 17 inch/min, 18 inch/min, 19 inch/min, 20, or within any range encompassed by any two of the foregoing values as endpoints. For example, the speed of the conveyor may be from 1 inch/min to 20 inch/min, 5 inch/min to 15 inch/min, or 6 inch/min to 12 inch/min.

As referenced above, to provide a flow of solvent passing through extractor 510, the extractor 510 is equipped with a solvent inlet 5110 that receives solvent devoid of extract or having a comparatively low concentration of extract. A solvent outlet 5112 is provided on a generally opposite end of the housing 5100 to discharge solvent having passed through extractor 510. Solvent outlet 5112 may be placed advantageously within the immersion and/or feed portion. In some embodiments it may be placed substantially at the level of the solvent line 5214. As solvent travels through the housing 5100 from inlet 5110 to outlet 5122, the solvent flows in a countercurrent direction from the flow of extrudate passing through the extractor 510. The solvent intermixes with extrudate, causing the extract carried by the extrudate to transfer from the extrudate to the solvent. Accordingly, in operation, solvent having a comparatively low concentration of extract enters at inlet 5110 while solvent having an increased concentration of extract discharges at outlet 5112. Likewise, fresh extrudate carrying extract enters at inlet 5106 while processed extrudate having a reduced concentration of extract is discharged at outlet 5108.

In some embodiments, the extrudate can be pre-wetted before it is contacted with solvent in the immersion portion.

In some embodiments, the extractor includes an inclined drain section 5216 located between the lower housing portion 5104 and the extrudate outlet 5108 and configured to allow solvent drainage from the extrudate. For example, in instances where extrudate is an oil-bearing material, solvent can extract oil out of the extrudate forming a miscella (the solution of oil in the extraction solvent) that is discharged through solvent outlet 5112.

In some embodiments, the extractor may include a plurality of recycle stages, wherein each stage is optionally separated by a divider. In some embodiments, the divider may include a stage separation baffle 5212 which maximizes recycle-liquid containment. The extractor may have three, four, five, or six stages.

FIGS. 7, 9, 10, and 11 illustrate cross sectional view of several components in the solvent/miscella recycling system. Referring to the drawings shown therein, scupper 5128 has a solvent and/or miscella recycle outlet 5604 at its bottom end. This outlet connects to the pool of solvent and allows solvent to be flow out from the immersion portion of the extractor. Scupper 5128 may be configured as an overflow weir in fluid communication with the immersion portion of the housing 5100. The openings are typically positioned below the solvent line 5214. The solvent and/or miscella recycle outlet 5604 controls downwards drainage from the solvent pool. The drained solvent and/or miscella can then be conveyed upwards back into the material bed in each of the recycle zones. The continuous circulation of solvent away from the top of the solvent line 5214 into the bottom of the material bed promotes turbulent mixing of the extrudate and the solvent.

In some embodiments, outlet 5604 may be a suction outlet connected to an external pump 5704 (FIG. 10) which conveys solvent from solvent/miscella outlet 5604 to solvent/miscella recycle inlet 5132 at the bottom of arrowhead assembly 5126 via recycle line 5702. Pump 5704 pressurizes the solvent/miscella recycle line to create a continuous circulation of solvent/miscella through the extrudate bed. If advantageous, the recycle inlets can be placed at locations in a desired array.

The speed of pump 5704 may be adjusted to fine tune the injection rate of the solvent into the extrudate bed. In preferred embodiments, the injection rate of the solvent may be as low as 0.1 in/s, 0.2 in/s, 0.3 in/s, 0.4 in/s, 0.5 in/s, 0.6 in/s, 0.7 in/s, 0.8 in/s, 0.9 in/s, 1 in/s, 1.5 in/s, 2 in/s, 2.5 in/s, 3 in/s, 3.5 in/s, 4 in/s, 4.5 in/s, 5 in/s, or within any range encompassed by any two of the foregoing values as endpoints. For example, the injection rate of the solvent may be from 0.1 in/s to 5 in/s, 0.5 in/s to 4 in/s, or 1 in/s to 3 in/s.

The solvent then rises through distribution manifold 5302 and into the inlet whistle block 5310. From inlet whistle block 5310, miscella or solvent is injected upward into the extrudate bed on the conveyor. The wide mouthed design of inlet whistle block 5310 creates a wide stream of solvent/miscella which treats a substantial portion of, or the entire width of the material bed or more. This wide jet stream of solvent/miscella promotes turbulent mixing of the extrudate in the solvent pool which results in increased extraction. Such a construction helps solvent to be delivered to areas of the bed that may not be washed well by a typical extractor as known in the prior art.

As flow emanates upwardly from arrowhead assembly 5126, it will disperse into the material bed. Effective height of the solvent penetration from the inlet is a function of drainage rate of the outlets, the rate and pressure of flow out of the weir 5120, the speed of conveyor assembly 5200, and the porosity of the material bed.

The solvent and extrudate may have a contact time of 1000 seconds to 10,000 seconds. The ratio of extrudate to solvent may be from 1:1 to 1:5.

What is claimed is:

1. A method of recovering a polymer material comprising:
providing an extrudate formed from an article comprising the polymer material;
contacting the extrudate with a solvent to form a mixture;
separating the mixture from the contacted extrudate, and
recovering the polymer material from the mixture.

2. The method of claim 1, wherein the extrudate is formed by feeding the article comprising the polymer material into an extrusion device.

3. The method of claim 2, wherein the article comprising the polymer material is dried before being fed into the extrusion device.

4. The method of claim 2, wherein the temperature is maintained at 80° C. to 120° C. as the article comprising polymer material is fed into the extrusion device.

5. The method of claim 2, further comprising the step of comminuting or processing the article comprising the polymer material to form article shreds before feeding the article into the extrusion device.

6. The method of claim 5, wherein an average diameter of the article shreds is from 20×20 mm to 40×40 mm or wherein an average size of the article shreds is from 4 cm² to 16 cm².

7. The method of claim 1, wherein the moisture content of the article comprising polymer material is less than 14%.

8. The method of claim 1, wherein the solvent is selected from the group consisting of 1,3-dimethyl-2-imidazolidone (DMI), dimethyl terephthalate (DMT), ethylene glycol, dimethylformamide (DMF), dichloromethane (DCM) and dimethyl sulfoxide (DMSO), and mixtures thereof.

9. The method of claim 1, wherein the solvent is 1,3-dimethyl-2-imidazolidone (DMI).

10. The method of claim 1, wherein the solvent is at a temperature of from 120° C. to 220° C.

11. The method of claim 1, wherein the polymer material comprises polyester, polyethylene, polyethylene terephthalate, polyamide, polyurethane, elastane, rayon, high density polyethylene, low density polyethylene, polypropylene, polystyrene, polyvinyl chloride, polycarbonate, polymethyl methacrylate, acrylonitrile butadiene styrene or mixtures thereof.

12. The method of claim 1, wherein the polymer material comprises polyethylene terephthalate (PET), polytrimethylterephthalate (PTT), or polyester (PE).

13. The method of claim 1, wherein the article comprises a fiber.

14. The method of claim 13, wherein the fiber comprises staple fiber, continuous filament fiber, or mixtures thereof.

15. The method of claim 13, wherein the fiber size is from 0.1 to 10 denier.

16. The method of claim 1, wherein the article comprises a plastic waste.

17. The method of claim 1, wherein the article comprises footwear, knitted fabric, woven fabric, a non-woven, carpet, or mixtures thereof.

18. The method of claim 1, wherein the extrudate comprises pellets.

19. The method of claim 18, wherein the pellets have an average diameter in cross section of from 6 mm to 16 mm or an average size of from 0.36 cm² to 2.6 cm².

20. The method of claim 18, wherein the pellets have an average weight of from 0.01 g to 100 g.

21. The method of claim 1, further comprising a step of pre-wetting the extrudate before it is contacted with solvent.

22. The method of claim 1, wherein the recovering step involves separating the polymer material from the solvent and drying it.

23. The method of claim 1, wherein the purity of the recovered polymer material is at least 70%.

24. The method of claim 1, wherein the contacting step is carried out in a percolation type extractor.

25. The method of claim 24, wherein the percolation extractor comprises:
an extraction chamber;
a screen configured to support the extrudate; and
a conveyance system configured to convey the extrudate along the screen in a direction of material travel.

26. The method of claim 24, wherein the extraction chamber further is configured to maintain a solvent pool in which the extrudate supported on the screen is partially immersed during operation.

27. The method of claim 24, wherein the extraction chamber further comprises a plurality of weirs extending from the top surface of the extraction chamber configured to drip solvent over the extrudate on the screen.

28. The method of claim 24, wherein the solvent is contacted with the extrudate in a countercurrent arrangement.

29. The method of claim 24, wherein the solvent and extrudate have a contact time of 1000 seconds to 10,000 seconds.

30. The method of claim 24, wherein the ratio of extrudate to solvent is from 1:1 to 1:3.

31. The method of claim 1, wherein the contacting step is carried out in an immersion type extractor.

32. The method of claim 31, wherein the immersion type extractor comprises:
a housing with an immersion portion configured to maintain a liquid pool in which the extrudate is immersible during operation of the extractor;
a conveyor assembly extending through the liquid pool configured to transmit the extrudate through the housing.

33. The method of claim 31, wherein the housing further comprises a plurality of bed decks positioned inside the housing, each providing a surface along with the extrudate material is conveyed during the operation of the extractor, and at least one of the plurality of bed decks being positioned at a vertically elevated position relative to another of the plurality of bed decks so as to define a drop zone where the extrudate material drops from the vertically elevated bed deck to a lower bed deck.

34. The method of claim 31, wherein the solvent and extrudate have a contact time of 1000 seconds to 10,000 seconds.

35. The method of claim 31, wherein the ratio of extrudate to solvent is from 1:1 to 1:5.

36. The method of claim 31, wherein the solvent and the extrudate are contacted in a countercurrent arrangement.

37. The method of claim 31, wherein the immersion type extractor further comprises: a plurality of recycle stages within the immersion portion, wherein each stage has a solvent recycle inlet positioned to direct a flow of solvent upwardly into the immersion portion wherein the solvent intermixes with the extrudate material; and
a further solvent recycle outlet.

38. The method of claim 37, wherein the solvent recycle inlets comprise a whistle inlet and a distribution manifold.

39. The method of claim 37, wherein the solvent recycle outlet is configured as an overflow weir and/or a suction outlet in fluid communication with the immersion portion of the housing.

40. The method of claim 37, wherein the conveyor assembly is configured to move the extrudate material in a countercurrent direction relative to solvent flow.

41. The method of claim 37, wherein the solvent and extrudate have a contact time of 1000 seconds to 5000 seconds.

42. The method of claim 37, wherein the ratio of extrudate to solvent is from 1:1 to 1:3.
